(19) United States
(12) Patent Application Publication
(10) Pub. No.: US 2025/0363640 A1
(43) Pub. Date: Nov. 27, 2025

(54) OBJECT DETECTION USING MULTI-CHANNEL DATA

(71) Applicant: Black Sesame Technologies Inc., San Jose, CA (US)

(72) Inventors: Meng Meng, Newark, CA (US); Xiaomin Liu, Sunnyvale, CA (US); Lei Zhang, San Jose, CA (US); Qun Gu, San Jose, CA (US)

(21) Appl. No.: 18/674,583

(22) Filed: May 24, 2024

(51) Int. Cl. G06T 7/12; G06T 5/20; G06V 10/762; G06V 10/764

(52) U.S. Cl. CPC G06T 7/12; G06T 5/20; G06V 10/762; G06V 10/764; G06T 2207/20028; G06T 2207/20032; G06T 2207/30252

(57) ABSTRACT

Methods, systems, and apparatuses, including computer programs encoded on computer storage media, for processing a sequence of frames. The methods comprise receiving sensor data capturing unlabeled objects in a sequence of frames. The sensor data comprises first-type and second-type sensor data. For each frame of the sequence of frames, the first-type sensor data is processed to generate one or more segmentation masks for the frame. A road mask representing road surface information is generated based at least on the one or more segmentation masks. For each frame in the sequence of frames, a correlation between the first-type sensor data and the second-type sensor data is generated. Using the respective correlations and the road mask, the second-type sensor data is filtered to remove a portion of the second-type sensor data that is irrelevant to the unlabeled objects. The remaining second-type sensor data is clustered to classify one or more unlabeled objects.

### BACKGROUND

This specification relates to detecting objects from sensor data, particularly to processing sensor data received from multiple channels and detecting objects that have not been labeled in the sensor data.

Object detection plays a pivotal role in the advancement of autonomous vehicles, enabling them to perceive and comprehend their surroundings accurately and in real time. Various object detection algorithms can be implemented to process sensor data for identifying and classifying objects such as pedestrians, vehicles, cyclists, and road signs, which ensures the safety of passengers and other road users, as well as facilitates efficient navigation and decision-making processes for autonomous vehicles.

Sensor data can have different forms and be collected by various sensors, e.g., image sensors, optical sensors, etc. An image sensor can capture a sequence of image frames and stream the sequence to a processor in real time for downstream processing. Each image frame represents a scene representing one or more objects. An optical sensor can include a light detection and ranging (LiDAR) sensor, which can generate a three-dimensional point cloud for each frame of multiple frames based on reflected optical signals for the frame.

Neural networks can be implemented for image processing. They generally include different neural network layers to process input images for different tasks, such as detection, classification, prediction, segmentation, etc.

### SUMMARY

This specification describes techniques for detecting objects from sensor data captured in multiple channels. In particular, the detected objects can be objects that have not previously been labeled and are predicted to belong to respective categories. The sensor data are collected in real-time and are formatted as a sequence of sensor data. The term “object” in this specification refers to any suitable objects captured in an image frame. For example, an object can include one or more road signs, billboards, or landmarks. In some situations, an object can be associated with one or more vehicles (e.g., wagons, bicycles, and motor vehicles). For example, an object can be a sticker or decal attached to a vehicle. As another example, an object can be a license plate affixed to a vehicle. In the context of the following description, the term “object” preferably relates to objects that are not commonly labeled in the sensor data (or input data). For example, an object here refers to an unlabeled object on the road, which can include an animal, a traffic cone, a construction sign, or other suitable unlabeled object on the road. For simplicity, the term “object” in the following description refers to unlabeled objects in the sensor data, and other labeled objects are referred to as “labeled objects.”

One aspect of the subject matter described in this specification can be embodied in a method that includes operations for processing a sequence of image frames to predict unlabeled objects therein. A system implementing the method receives a sequence of sensor data for multiple frames or time steps. The sensor can include multiple types captured by different sensors. For example, first-type sensor data can be measured by one or more first-type sensors, and second-type sensor data can be measured by one or more second-type sensors. One or more of the sensor data can capture objects that are not labeled, and the system can efficiently predict these unlabeled objects by implementing the method.

The first-type sensors can include one or more cameras located on a vehicle. The first-type sensor data can include a respective sequence of two-dimensional image frames captured by each of the one or more cameras. The second-type sensor can include a LiDAR sensor, and the second-type sensor data can include a sequence of three-dimensional point clouds.

First, the method includes processing the first-type sensor data to generate multiple segmentation masks for each frame of the sequence of frames. For cases where the first-type sensor data includes images captured by multiple cameras, the method includes processing, for each camera of the multiple cameras, an image captured by the camera for a current frame to generate a detection result. The detection result can include data indicating pixels in the image that represent a road surface for the current frame. Then, the method includes transforming the detection results for all images for the frame captured by all cameras into a respective free space detection contour and then transforming these contours into one or more segmentation masks.

The method then includes operations to generate a road mask for the frame by fusing the one or more segmentation masks for the frame. This step can be repeatedly performed for each frame in the sequence of frames. The road mask represents road surface information. In general, the road mask includes a bird's eye view (BEV) road mask represented in a BEV coordinate frame. The method can further includes operations to refine the BEV road mask, e.g., performing one or more morphological operations or one or more bilateral filtering operations.

The method further includes operations to generate a correlation between the first-type sensor data and the second-type sensor data for each frame in the sequence of multiple frames. To generate the correlation and for cases where the second-type sensor data include three-dimensional (3D) point clouds captured by a LiDAR sensor, a system implementing the method can project each point of the 3D point cloud for each frame into the BEV coordinate frame; and match the projected points with pixels in the two-dimensional images that represent the road surface for the corresponding frame.

Based on the correlations and the road mask, the method includes operations to filter the second-type sensor data to remove a portion of the second-type data that is irrelevant to the unlabeled objects captured in the sequence of frames. The method then includes operations to cluster the remaining second-type sensor data to classify one or more unlabeled objects.

In some aspects, the method can further improve the accuracy of the BEV road mask by generating a dense BEV road mask. For example, the system can aggregate multiple BEV road masks for a couple of frames. To aggregate, a system implementing the method can first select a frame from the frames as a reference frame. The system can then convert the BEV road masks for frames other than the reference frame to the reference frame. The system can stack the converted BEV road masks to generate the dense BEV road mask.

In some implementations, the reference frame can be a frame in the middle of the selected frames in the sequence. For example, a frame at the median position in the selected sequence of frames can be chosen as the reference frame. In addition, for efficiency purposes, the system can select multiple frames in the sequence of frames at a particular interval to generate dense BEV road masks.

Other embodiments of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

Particular embodiments of the subject matter described in this specification can be implemented to realize one or more of the following advantages. For example, the described techniques can improve the accuracy, robustness, efficiency, and compatibility of detecting and analyzing unlabeled objects from sensor data.

The described techniques can enhance the accuracy of detecting and analyzing unlabeled objects from sensor data. First, a system implementing the described techniques can fuse sensor data from different channels. For example, for each frame of a sequence of frames, the system is configured to fuse three-dimensional point clouds generated by a LiDAR for the frame and a two-dimensional image produced by an image sensor (e.g., a camera) for the frame. Unlike existing techniques that perform object detections based on a single/sole type of sensor source (e.g., solely LiDAR or image sensors), the described fusion technique can use and combine the strengths of sensor data collected/generated by sensors of multiple channels or modalities. Information collected from different types of sensor data can complement each other in various ways. The described techniques can ensure more precise localization, segmentation, and estimation of 3D bounding boxes for unlabeled obstacles using the sensor data from multiple channels, thereby enhancing the overall accuracy of obstacle detection.

In addition, the described techniques can generate a comprehensive representation of the road scene using a bird's-eye-view (BEV) road mask for each frame of multiple frames. Together with the fused sensor data from multiple channels, the BEV road mask can accurately locate and segment data representing a road surface. BEV road masks enable the system to filter out sensor data that have been labeled (e.g., LiDAR points that represent a road) and/or are irrelevant to the road surface. The system can further denoise the BEV road masks by aggregating multiple BEV road masks for different frames to generate a dense BEV road mask. This way, the described techniques can reduce and even eliminate the inaccuracy introduced by the sparsity and empty regions in single-frame detection. Thus, the dense BEV road masks can further enhance the accuracy of identifying and clustering unlabeled obstacles with precise 3D bounding boxes.

The described techniques can further improve the robustness of detecting unlabeled objections. More specifically, the existing object detection techniques for autonomous driving are unable to label every type of object present in a road scene since the pre-labeling process is labor-intensive and not automatic (e.g., heavily relied on human labeling). The described techniques, however, can identify data representing unlabeled objects and cluster them into different categories, which allows for robust detection and analysis of a wide range of “not that common” objects, e.g., animals, traffic cones, construction signs, etc.

Additionally, the described techniques can improve the efficiency of detecting objects, even when the sensor data are limited due to particular environments (e.g., sensor data captured in bad weather or light conditions). The described techniques can reduce computation costs by selectively processing a sequence of sensor data at intervals of different sizes according to various requirements for object detection and the quality of sensor data. The described techniques can select sensor data with good quality and adjust the interval sizes strategically. The described techniques can further perform operations of detecting and analyzing objects in parallel, e.g., distributing the operations across different hardware accelerators or processors. The described techniques can thus enable objection detection in real-time and are even capable of handling sensor data in resource-limited environments.

Last but not least, the described technique can ensure compatibility between the sensor data and the industrial standards for datasets. The described techniques generally follow mainstream formats and standards for LiDAR data annotation, ensuring compatibility with datasets collected using different methods. The described techniques can also provide prediction data (e.g., clustered data representing previously unlabeled data) for a wide range of scenarios, covering urban and suburban environments and diverse weather and/or light conditions. Due to the data compatibility, the generated predictions for unlabeled objects can contribute to various downstream operations such as validation, analysis, benchmarking, etc.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example of an unlabeled object detecting system configured to generate output data after processing input data.

FIG. 2 illustrates an example road mask generator configured to generate filtered data after processing input data.

FIG. 3 illustrates an example detection result that highlights pixels representing a road surface.

FIG. 4 illustrates different examples of bird's eye view (BEV) road masks.

FIG. 5 illustrates an example BEV road mask before and after identifying and processing connected components in the BEV road mask.

FIG. 6 is a flow diagram of an example process for processing input data to detect unlabeled objects.

Like reference numbers and designations in the various drawings indicate like elements.

### DETAILED DESCRIPTION

The described techniques relate to detecting and predicting unlabeled objects using sensor data from multiple channels for a road scene where an autonomous vehicle operates. Unlike existing techniques, where objection detection heavily relies upon intensive human annotation on pre-defined object classes, the described techniques can efficiently and accurately identify objects that are not previously defined/classified. In addition, sensor data from multiple channels, for example, can include data captured by an optical sensor, e.g., LiDAR. Sensor data can further include data captured by an image sensor, e.g., a camera. LiDAR data can be generated in the form of a three-dimensional point cloud for each frame of a sequence of frames, and the image data can include a sequence of two-dimensional image frames capturing a respective scene.

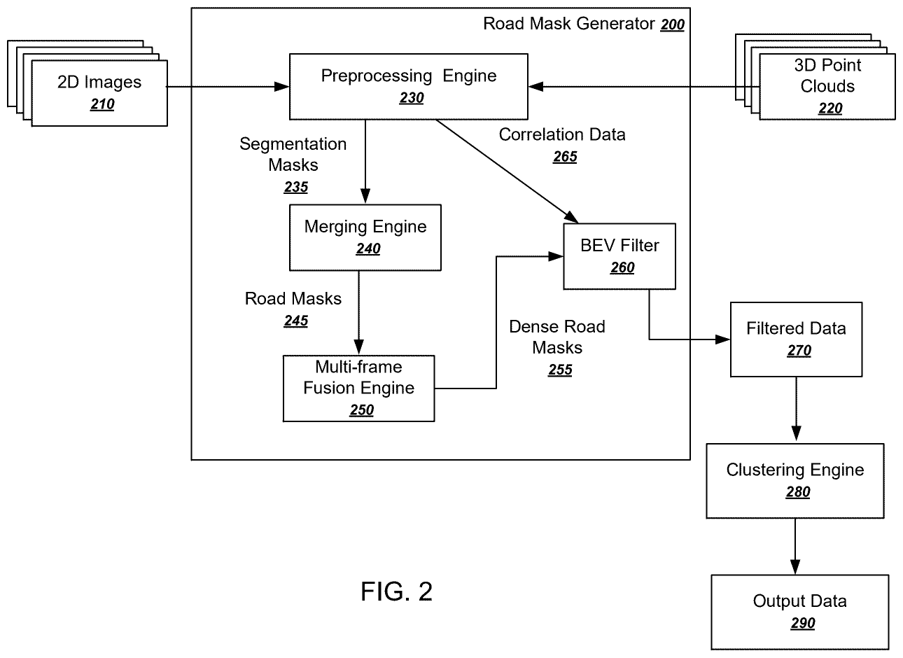

To use the strengths of different data types (e.g., LiDAR point cloud and images), the described techniques can efficiently fuse sensor data from different types of sensors. In some implementations, the described techniques can be used as a standalone function for generating training data (when training data is not available or too scarce) for training a deep learning model. Alternatively, the described techniques can be integrated with a deep learning model to supplement detections of unlabeled objection classes. To fuse the data, the described techniques can generate a correlation between the different types of sensor data. Based at least on the correlation, the described techniques can filter data points that are irrelevant to unlabeled objects of interest. The described techniques can then cluster and classify objects based on the filtered data. More details of the fusion and filtering operations/steps are described in greater detail below in connection with FIG. 2. In the following description, irrelevant data points, for example, can include data points representing a road surface, objects away from the road surface, objects that are previously labeled, etc. The unlabeled objects of interest, within the context of the following description, can include animals, traffic cones, construction signs, etc.

The described techniques can further enhance accuracy and robustness by denoising the sensor data. For example, the described techniques can aggregate information from multiple frames to denoise, perform connected component analysis, or use denoise filters. In addition, the described techniques can further enhance efficiency by performing operations non-synchronously in parallel, and selectively processing sensor data within a sequence at a specific interval (or at different intervals). More details are described below in connection with FIGS. 2, 4, and 5.

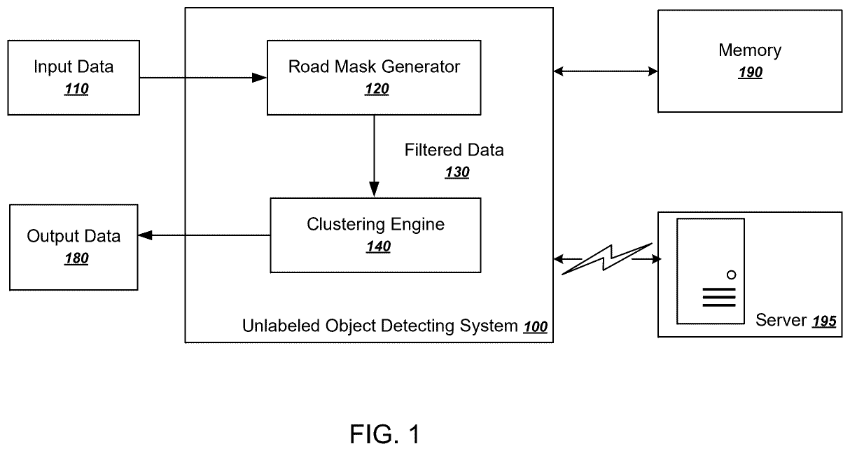

FIG. 1 illustrates an example of an unlabeled object detecting system 100 configured to generate output data 180 after processing input data 110. The unlabeled object detecting system 100 can be implemented on one or more computers or processors at one or more locations. The one or more computers or processors can be coupled with one another wirelessly or by wires. The one or more computers or processors can include one or more CPUs, GPUs, TPUs, or other suitable types of processors. For simplicity, the unlabeled object detecting system 100 is referred to as system 100 in the following description.

As shown in FIG. 1, system 100 can include one or more modules that are configured to perform different operations to process input data 110. For example, system 100 includes a road mask generator 120 to receive and process input data 110 to generate filtered data 130. The filtered data 130 are then passed into clustering engine 140 of system 100 to generate output data 180. Details of the operations performed by the road mask generator 120 and clustering engine 140 are briefly described below, and more details are described in connection with FIG. 2.

Input data 110 generally includes sensor data collected or generated through different types of sensors via different channels. In the context of autonomous driving, the sensors are generally located in an autonomous driving vehicle. For example, input data 110 can include two types of sensor data. The first type of data is generated by one or more first-type sensors, and the second type of data is generated by one or more second-type sensors. For simplicity and within the context of autonomous driving, the first-type sensors can include LiDAR sensors, and the first type of data are sensor data collected by LiDAR sensors. For each frame of a sequence of frames, LiDAR sensors can transmit optical signals and receive reflected optical signals to generate a holistic view of the surrounding environment (e.g., objects in the vicinity) and generate sensor data formatted as a three-dimensional point cloud for the frame.

In general, a point cloud generated by LiDAR is a digital representation of the surrounding environment in three dimensions. By combining distance measurements based on the reflected optical signals with the angles at which the optical signals were emitted, LiDAR generates a collection of three-dimensional points in space (i.e., a three-dimensional point cloud). Each point in the point cloud represents a location where the optical signal is reflected off an object. Accordingly, point clouds can provide detailed spatial information about the surrounding environment, enabling operations such as mapping, object detection, and navigation for autonomous vehicles and other systems.

The second-type sensors can include image sensors such as a camera, a video recorder, a surveillance camera, etc. The second type of data includes a sequence of two-dimensional images, each capturing a respective scene for the frame. For autonomous driving vehicles, the described techniques can include more than one camera. For example, the described techniques can include six cameras located at different positions on an autonomous driving vehicle and each of the six cameras can face a respective direction, e.g., a front camera facing the front, a front left camera facing the front to the left, a front right camera facing the front to the right, a rear left camera facing the rear to the left, a rear right camera facing the rear to the right, and a rear camera facing the rear. In some implementations, for each image frame of a sequence of frames captured by each of the six cameras, the system can project the image frame into a bird's eye view (BEV) coordinate. The system can generate a BEV view for a current time step using image frames captured by the six cameras at the current time step.

Each image of the sequence of two-dimensional images can include pixels that capture one or more objects. Some pixels (or segments of pixels) of an image can represent one or more previously-labeled objects, such as a vehicle, a pedestrian, or a road sign. The remaining pixels in the 2D images can represent additional objects, such as the road surface where an autonomous vehicle operates, objects away from the road (i.e., on the curbsides or in the opposite lane or the bike lane of the road), or objects that are not labeled classes. Unlabeled classes or objects can include non-human beings such as cats, dogs, or other types of animals, road cones, construction signs, or other types of objects that are not previously labeled.

That said, although the description above illustrates sensors such as LiDAR and an image sensor for ease of explanation, it should be noted that the described techniques can be applied to other sensor data collected or generated by other types of sensors, according to different requirements for object detection.

The road mask generator 120 is configured to fuse the input data 110, particularly, sensor data from different channels with different modalities. In general, the road mask generator 120 can process the two-dimensional images to generate a segmentation mask for each image frame of a sequence of image frames captured by one of multiple cameras. The segmentation mask can identify pixels representing a road surface. The road mask generator 120 can further merge corresponding segmentation masks generated for the frame and for all of the multiple cameras to generate a BEV road mask. The road mask is called a BEV road mask because it is projected in the BEV coordinate, which surrounds the autonomous driving vehicle. Note that although the merging process is described in connection with image frames, one should appreciate it that the described merging process can be applied to other types of sensor data, e.g., video clips, depth images, etc.

The road mask generator 120 can further denoise the generated BEV road mask using various techniques, e.g., aggregating BEV road masks from different frames to generate a dense BEV road mask, filtering noises using different filters such as a bilateral filter, a median filter, or a Gaussian filter, or performing connected component identification to remove fragmented and noisy regions.

For each frame of a sequence of frames, the road mask generator 120 can establish a correlation between the corresponding three-dimensional point cloud from the LiDAR sensor and the two-dimensional images from different cameras. The road mask generator 120 can project the point cloud into the BEV coordinate based on the correlation, and the projected point cloud is filtered by road mask generator 120 using the dense BEV mask to remove points that are irrelevant to unlabeled objects positioned on the road surface. The irrelevant points can represent, as described above, objects that are previously labeled (e.g., vehicles, pedestrians, road signs, etc.), objects that are not on the road surface (e.g., on the curbsides or on the opposite/bike lanes), or points representing the road surface. The road mask generator 120 generates filtered data 130 after applying the dense BEV mask to the projected point cloud, and the filtered data 130 is then fed to clustering engine 140 for further processing.

In general, the clustering engine 140 is configured to cluster the filtered data for the frame (e.g., remaining points in the point cloud) to obtain three-dimensional clusters representing unlabeled objects on the road. System 100 does not need to associate a particular name with each of the classes. Rather, the identified objects can be simply labeled using alphabets, numbers, bins, etc. The clustering engine 140 is further configured to estimate a three-dimensional bounding box for each of the three-dimensional clusters. System 100 can output the three-dimensional bounding boxes generated by the clustering engine 140 as output data 180. In some implementations, the output data 180 can further include one or more segmentation masks, one or more BEV masks, one or more dense BEV masks, one or more filtered point clouds, one or more three-dimensional clusters, and one or more numerical labels/bins for the clusters. More details related to operations performed by the road mask generator 120 and clustering engine 140 are described below in connection with FIG. 2.

In addition, system 100 can be communicatively coupled with a memory unit 190.

Memory unit 190 can be local or remote to the license plate processing system 100. In some cases, memory unit 190 is generally configured to store parameters for system 100. For example, memory unit 190 can store model parameters for road mask generator 120 and/or clustering engine 140. Memory unit 190 can also provide these stored parameters to system 100 for performing operations to process input data 110. In addition, the memory unit 190 may optionally be configured to store and provide input data 110 to system 100, or temporarily store output data 180, or both.

System 100 can be communicatively coupled to a server 195. Server 195 generally receives user requests for processing input data 110 using the system 100. In some cases, server 195 can receive and further process output data 180 to generate instructions to control/maneuver the autonomous driving vehicle in real-time. In some cases, server 195 can generate instructions that, once executed by the unlabeled object detecting system 100, cause system 100 to process input data 100 using different algorithms via road mask generator 120 and/or clustering engine 140. The instructions can further include operations related to parallel computation, skipping frames for reduced computation, fusion operations, etc.

FIG. 2 illustrates an example road mask generator 200 configured to generate filtered data 270 after processing input data. Road mask generator 200 is similar to the road mask generator 120 of FIG. 1. The output data 290 are similar to the output data 180 of FIG. 1. The input data in FIG. 2 can include a sequence of 2D images 210, and a corresponding sequence of 3D point clouds 220. Filtered data 270 is similar to filtered data 130 of FIG. 1. Road mask generator 200 can be implemented on one or more computers or processors located at one or more locations. The one or more computers or processors can be coupled with one another wirelessly or by wires. The one or more computers or processors can include one or more CPUs, GPUs, TPUs, or other suitable types of processors.

Road mask generator 200 first receives one or more sequences of two-dimensional (2D) images 210 as input. The 2D images 210 are captured by one or more image sensors (e.g., cameras) located at different positions of an autonomous driving vehicle and facing in different directions. As described above, the cameras can include six cameras respectively facing front, front right, front left, rear, rear left, or rear right. Thus, 2D images 210 include, for each camera of the six cameras, a respective sequence of 2D images for a period of time.

The road mask generator 200 can include a preprocessing engine 230 configured to process, for each sequence of one or more sequences of the 2D images 210, the 2D image sequence 210 for generating segmentation masks 235 for the sequence. More specifically, for each image frame of the sequence of image frames captured by one of the cameras, the preprocessing engine 230 can generate a segmentation mask representing the road surface for the camera and for the frame.

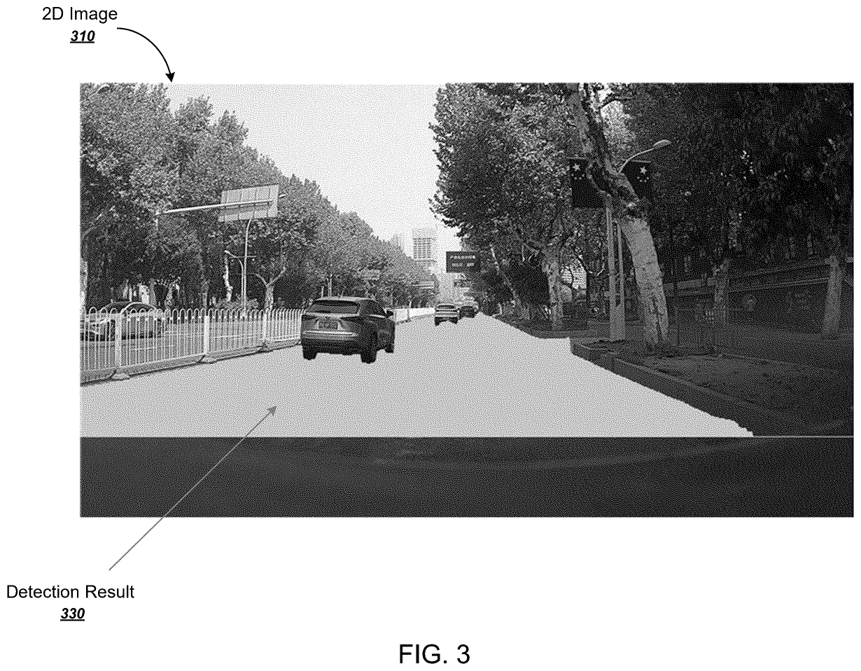

To generate a segmentation mask for an image frame captured by one camera, the preprocessing engine 230 is configured to process the image frame to obtain road detection results, which include pixel-wise information indicating which pixels represent the road surface. One example is illustrated in FIG. 3, where the detection result 330 is generated (and highlighted) for 2D image 310 captured by a front camera of the multiple cameras located on an autonomous vehicle. The preprocessing engine 230 is further configured to transform the road detection results into a segmentation mask for the image frame captured by the camera. The system can implement different techniques to transform road detection results into a segmentation mask. One example technique includes transforming a free space detection contour (e.g., the highlighted region of FIG. 3) into a segmentation mask 235, which is then used to segment pixels representing the road region in the image. Note that the segmentation mask is measured under the coordinate frame associated with the camera. The preprocessing engine 230 can repeatedly perform the above-described techniques to generate a respective sequence of segmentation masks 235 for each of the multiple cameras using the sequence of image frames captured by the camera.

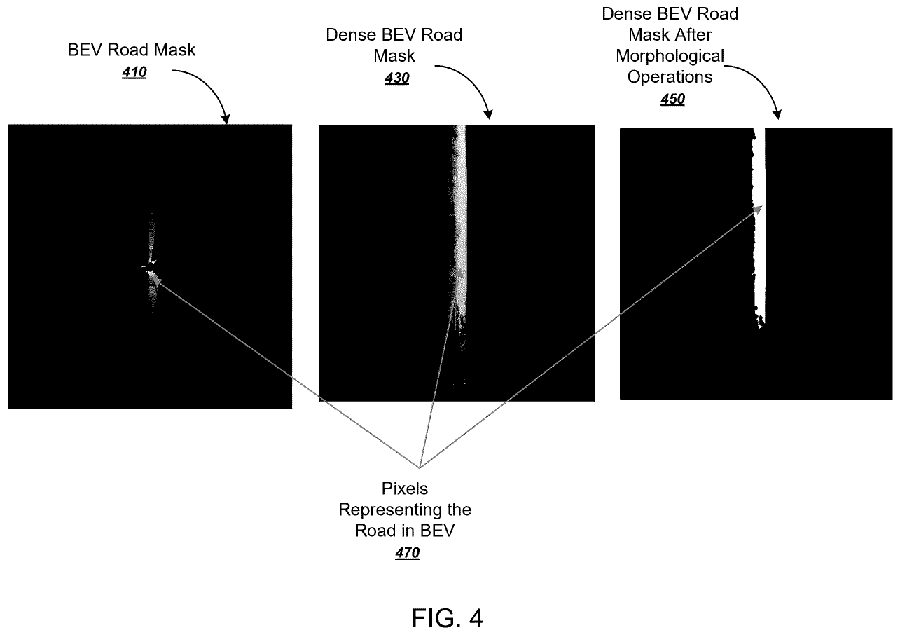

The generated segmentation masks 235 are then provided to merging engine 240 of the road mask generator 200 for further processing. For each frame of multiple frames, merging engine 240 is configured to merge respective segmentation masks 235 associated with different cameras for generating a BEV road mask 245. More specifically, for each frame of multiple frames, the merging engine 240 can project the respective segmentation masks 235 from a respective camera's coordinate frame into a BEV coordinate frame, and merge the projected segmentation masks 235 into a BEV road mask 245. One example BEV road mask 245 is illustrated in FIG. 4 with numerical reference 410. The merging engine 240 can repeatedly perform the above-noted operations to generate a sequence of BEV road masks 245 for the sequence of frames.

The road mask generator 200 further includes a multi-frame fusion engine 250 to improve the quality of the BEV road masks 245 using different techniques, e.g., aggregating or fusing BEV road masks 245 from multiple frames to generate one or more dense BEV road mask 255. Note that the fusing operations are different from the fusing operations performed by merging engine 240.

In general, a BEV road mask 245 generated for a single frame tends to be sparse and can include a significant number of null or empty regions due to object occlusion in 2D images collected by multiple cameras. To improve the information density, the multi-frame fusion engine 250 can accumulate road surface information across multiple frames in the sequence of frames by aggregating BEV road masks 245 from multiple frames for generating a dense representation of the BEV road mask, i.e., a dense BEV road mask 255. To aggregate BEV road masks 245 from multiple frames, the multi-frame fusion engine 250 sets a coordinate frame as a reference frame. The multi-frame fusion engine 250 then converts BEV road masks in each of the selected frames for fusion into the reference coordinate frame and stacks the BEV road masks 245 on top of each other to generate a dense BEV road mask for the reference frame. Note that the BEV road masks are converted according to the reference frame to take into consideration the pose and time differences between different frames. In some implementations, the BEV road masks can be projected into a three-dimensional space, which is in harmony with the three-dimensional space of point clouds collected by the LiDAR sensor. In these cases, the reference coordinate frame is a three-dimensional coordinate frame, and the stacking process takes place in the three-dimensional coordinate frame.

In addition, multi-frame fusion engine 250 is also configured to select one frame out of multiple frames as the reference frame for better performance. In some implementations, multi-frame fusion engine 250 is configured to select a reference frame that is away from the first and last frames in the sequence to avoid undesired distortion in conversion. For example, a frame in the middle of the sequence (e.g., a median frame) can be selected as the reference frame. Moreover, multi-frame fusion engine 250 can generate a dense BEV road mask 255 using a different number of frames. For example, for a sequence of a hundred frames, the dense BEV road mask 255 can be generated using two frames, five frames, ten frames, fifty frames, or other suitable numbers of frames up to the total hundred frames.

Road mask generator 200 is further configured to implement other techniques to improve the quality of BEV masks 245 (or dense BEV masks 255), e.g., morphological image processing operations, filtering operations, or other suitable operations. Morphological image processing operations can include, for example, open operation, a type of spatial operation used to enhance or modify the geometrical structure of objects within an image (and here, a BEV road mask). An open operation typically includes two fundamental operations: erosion (where each pixel is examined under one or more criteria and only satisfying pixels remain) followed by dilation (expanding remaining pixels based on the same one or more criteria). As an example, road mask generator 200 employs a cross-shaped structuring element as a kernel. The term “cross-shaped” here generally refers to a dilation process where the central pixel and its immediate neighbors to the left, right, top, and bottom are used for enhancing or modifying the geometrical structure of an object in an image.

The kernel can also have a pre-determined pixel size or shape, e.g., 5 by 5 matrix, 7 by 7 matrix, 10 by 10 matrix, or other suitable sizes according to different task requirements. Note that the kernels can be tailored for different denoise requirements and can be customized for particular road, weather, light, or traffic conditions, to maximize the denoise results.

Filter operations can include bilateral filtering to filter noise information. Bilateral filtering can effectively preserve important details while suppressing noise in data. More specifically, bilateral filtering includes filtering in both the spatial domain and intensity domain. Bilateral filtering considers both a local pixel within its spatial context and the gradient in intensity around the local pixel. By incorporating both spatial and intensity domains, bilateral filtering can effectively preserve edges while reducing noise in the data. In some implementations, median filtering and Gaussian filtering can also be implemented for different denoise purposes.

Moreover, the road mask generator 200 can perform connected component identification operations to clean up the BEV road masks 245 (or dense BEV road masks 255) and remove fragmented, noisy regions from the BEV road masks 245. More details of the connected component identification operations are described below in connection with FIG. 4.

The preprocessing engine 230 is further configured to receive data captured by a LiDAR sensor as an input. The LiDAR data can be generated in the form of a sequence of three-dimensional (3D) point clouds 220. Each point in a 3D point cloud, as described above, represents a location where an optical signal is reflected at the time step associated with the frame.

After receiving the sequence of 3D point clouds 230, preprocessing engine 230 is configured to generate a correlation between the sequences of 2D images and the sequence of 3D point clouds and then output correlation data 265 representing at least the correlation. More specially, for each frame of the sequence of frames, preprocessing engine 230 is configured to project the 3D point clouds for the frame into a respective 2D coordinate frame for a corresponding camera. Preprocessing engine 230 then matches the projected 3D points with corresponding pixels in the respective 2D coordinate frame. Since preprocessing engine 230 has already generated the segmentation masks 235 for filtering pixels for the road surface, preprocessing engine 230 can label the projected points that are associated with the road surface pixels as road surface points. For example, as shown in FIG. 3, points projected from a corresponding 3D point cloud are labeled as “road” if they fall into the segmented portion representing the road surface.

Next, the preprocessing engine 230 is configured to determine BEV coordinates for the 3D point cloud for each frame of the sequence of multiple frames based on the correlation between the sequences of 2D images and the corresponding sequence of 3D point clouds. In other words, the preprocessing engine 230 can be configured to project the 3D point clouds in the BEV coordinate frame for the corresponding frame in the sequence of frames. Projecting the 3D point clouds from a 3D space into the BEV coordinate frame (more specifically, the same reference BEV coordinate frame as the one for generating the dense BEV road mask) can provide a comprehensive 2D representation of the scene captured by the sensors from a top-down perspective, enabling a clear visualization of the spatial distribution of the points. Note that correlation data 265 can include the projected points for each frame in the sequence of frames.

The road mask generator 200 can further include a BEV filter 260 configured to receive the correlation data 265 and the dense road masks for the sequence of frames. The BEV filter 260 is configured to apply the corresponding dense rod masks 255 over the projected 3D points for each frame of the sequence of frames to generate filtered data 270. The filtered data 270 can include the remaining points after the BEV filter 260 filters out points that are irrelevant to the unlabeled objects on the road.

To apply the dense road masks 255 over projected points in the BEV coordinate frame, the BEV filter 260 is first configured to identify and remove ground points in the projected points using a ground segmentation algorithm, which can include Patchwork++ or other suitable algorithms. Here, ground points generally refer to points that are associated with the road surface and labeled as “road” as described above. In some implementations, road mask generator 200 can apply the ground segmentation algorithm to filter out ground points (or “road” points) in the three-dimensional space, after which only non-ground points remain.

The BEV filter 260 then applies the dense BEV masks 255 to the sequence of remaining non-ground points to filter out points that are irrelevant to the unlabeled objects. For example, the BEV filter 260 can determine whether a projected point has a BEV coordinate located within the horizontal region representing the road. If the projected point has a BEV coordinate located outside the boundary of the horizontal region representing the road, this projected point will be filtered out by BEV filter 260. In addition, the BEV filter 260 further determines whether a projected point has been previously labeled, and if so, this projected point is filtered out. The remaining points in the filtered data 270 can potentially represent unlabeled objects on the road surface.

Note that in applying the dense BEV road masks 255, the BEV filter can further convert the projected 3D points into the same reference frame as the dense BEV road masks 255 to eliminate the differences in time and space.

The clustering engine 280 is configured to cluster the remaining points in the filtered data 270 to generate one or more 3D clusters representing respective objects on the road. Again, the respective objects represented by the 3D clusters are objects that are not previously labeled in the 2D images 210, nor in the 3D point clouds 220. In some implementations, the clustering engine 280 can perform Density-Based Spatial Clustering of Applications with Noise (DBSCAN) clustering on the filtered points in the BEV coordinate frame. In general, DBSCAN clustering is a clustering algorithm configured to cluster special data points based on the data density. To implement the DBSCAN clustering algorithm, clustering engine 280 starts by randomly selecting a point in the filtered points. If the point is a core point, clustering engine 280 expands the cluster by recursively adding all reachable points within the &-neighborhood of the core point. This process continues until no more points can be added to the cluster. Any unvisited points that are not noise points are then assigned to a new cluster or labeled as noise points.

The clustering engine 280 is further configured to estimate 3D bounding boxes for the respective objects based on one or more 3D clusters. The output data 290 generated by the clustering engine 280 can include the estimated bounding boxes. In some cases, the output data 290 can further include one or more segmentation masks, one or more BEV masks, one or more dense BEV masks, one or more filtered point clouds, one or more three-dimensional clusters, and one or more numerical labels/bins for the clusters, as described above.

FIG. 3 illustrates an example detection result 330 that highlights pixels representing a road surface. As shown in FIG. 3, the system (e.g., road mask generator 120 of FIG. 1, road mask generator 200 of FIG. 2, or preprocessing engine 230 of FIG. 2) is configured to process a 2D image for a frame in a sequence of frames captured by a particular camera located on an autonomous driving vehicle. The 2D image 310 is captured by a front camera located on the autonomous driving vehicle facing in the front direction. As described above, the autonomous driving vehicle can be mounted with multiple cameras facing in different directions, e.g., front, front right, front left, rear, rear right, and rear left. The system can generate detection result 330 for the 2D image 310, and detection result 330 includes a portion of pixels in the 2D image that are classified or labeled as road surface. In some implementations, the detection result 330 can represent a free space detection contour. The detection result 330 for the frame can be further processed by the system to generate a segmentation mask for the frame captured by the front camera. More specifically, the detection result 330 is transformed by the system from the free space detection contour representing the road surface into a segmentation mask. Note that although FIG. 3 illustrates a 2D image captured by a front camera for the east of the illustration; one should appreciate that the system can process other 2D images captured by other cameras located in the vehicle for different frames.

FIG. 4 illustrates different examples of bird's eye view (BEV) road masks. BEV road mask 410 for a frame represents a road mask in BEV coordinate generated based on sensor data collected by multiple sensors for the frame. Dense BEV road mask 430 represents a road mask generated by aggregating multiple BEV road masks 410 for multiple frames. As described above, the system described above first selects a reference frame. Then, the system converts BEV road masks of other frames into the reference frame and stacks the converted BEV frames to generate the dense BEV road mask 430. The system can further perform morphological operations to further improve the quality of the dense BEV road mask 430 to generate the dense road mask 450. The morphological operations, as described above, can include open operations, a type of spatial operation including erosion operations and dilation operations.

Note that the bright regions in BEV road mask 410, and dense BEV road masks 430 and 450 include pixels 470 (or the bright region) represent the road surface in the BEV coordinate frame. The bright region in the single-frame BEV road mask 410 is the smallest compared to dense BEV road masks 430 and 450. The dark region in BEV road mask 410 generally represents non-road-surface for the frame. In addition, the single-frame BEV road mask 410 includes noise points scattered around the bright region. Dense BEV road mask 430 is generated by stacking multiple single-frame BEV masks of different frames, as described above. Accordingly, as shown in FIG. 4, dense BEV road mask 430 has a longer and wider bright region than the single-frame BEV road mask 410, yet still includes a fuzzy boundary due to noise. After performing the morphological operations, the bright region in the dense BEV road mask 450 becomes the brightest, with clearer boundaries and less noise among BEV road mask 410 and dense BEV road masks 430 and 450.

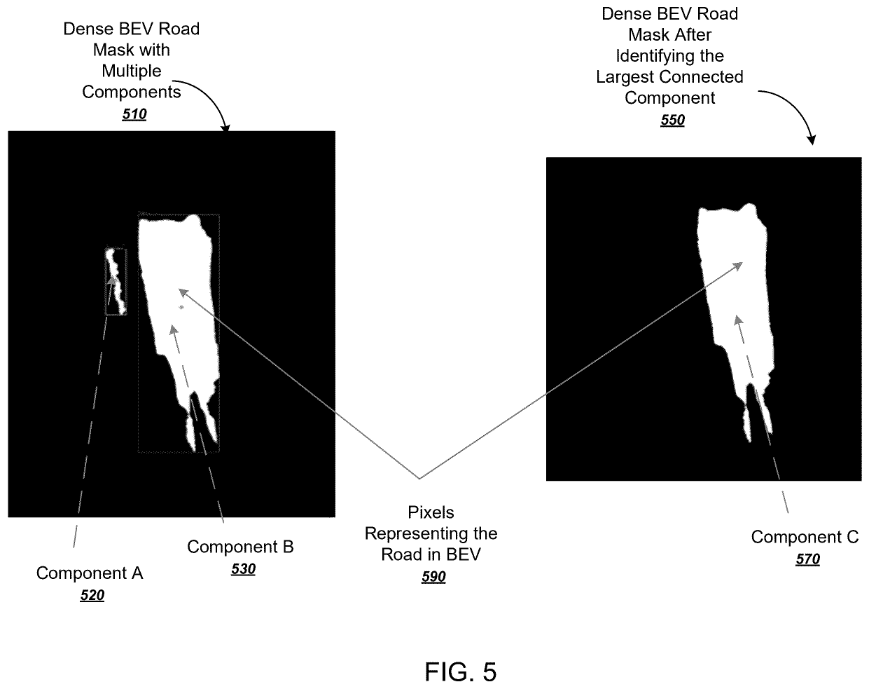

FIG. 5 illustrates an example BEV road mask before and after identifying and processing connected components in the BEV road mask. As shown in FIG. 5, a dense BEV road mask 510 can include more than one bright component, e.g., component A (520) and component B (530). The bright regions in dense BEV road mask 510 represent pixels representing the road surface projected in the BEV coordinate frame. As shown in FIG. 5, component A (520) has a smaller size than component B (530).

To further clean up the BEV road mask 510 and remove fragmented, noisy regions around the bright regions, the system described herein can identify and label connected regions to preserve only the largest connected components. For example and as shown in FIG. 5, the system determines that component B (530) in the dense BEV road mask has the largest area, and keeps only component B (530). The system can further implement other techniques to denoise component B (530) in the dense BEV road mask 510. For example, the system can apply one or more filtering techniques, such as bilateral filtering, median filtering, Gaussian filtering, or other suitable filtering techniques, to further denoise component B (530). After implementing the largest component identification operations and other denoising techniques, the system can generate a new dense BEV road mask 550 with only one bright region, i.e., component C (570). As shown in FIG. 5, component C (570) has a cleaner boundary with less noise near the boundary.

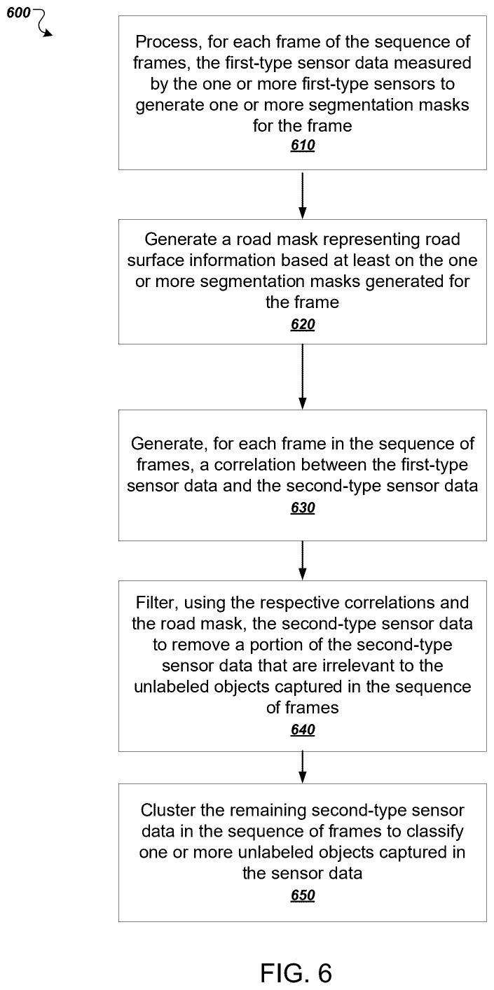

FIG. 6 is a flow diagram of an example process 600 for processing input data to detect unlabeled objects. For convenience, the example process 600 is described as being performed by a system of one or more computers located in one or more locations. For example, the license plate processing system 100 of FIG. 1, when appropriately programmed, can perform the process 600.

In general, the system can perform operations for identifying unlabeled objects captured in sensor data. The sensor data represent one or more scenes in a sequence of frames. The sensor data include first-type sensor data measured by one or more first-type sensors and second-type sensor data measured by a second-type sensor. As described above, the one or more first-type sensors can include one or more cameras located on a vehicle. Each of the one or more cameras can face a respective direction. For example, an autonomous driving vehicle can be mounted with six cameras, respectively facing front, front right, front left, rear, rear right, and rear back. The first-type sensor data can include a respective sequence of two-dimensional image frames captured by a respective camera of the one or more cameras. In addition, the second-type sensor comprises a LiDAR sensor, and the second-type sensor data can be a sequence of three-dimensional point clouds. The sequence of three-dimensional point clouds corresponds to the respective sequence of images captured by each camera of multiple cameras. In some implementations, the sequence of three-dimensional point clouds can have a time offset from the sequence of two-dimensional images. The system is configured to match the point cloud sequence with the image sequences by shifting the point cloud sequence or the image sequences based on the time offset.

To identify unlabeled objects in the sensor data, the system processes, for each frame of the sequence of frames, the first-type sensor data measured by the one or more first-type sensors to generate one or more segmentation masks for the frame (610). To generate one or more segmentation masks for the first-type sensors, the system first generates a respective detection result for each of the first-type sensors. More specifically, when the first-type sensors are cameras and the first-type sensor data include a sequence of 2D images captured by each of the cameras, the system processes, for each camera of the one or more cameras, a two-dimensional image captured by the camera for the frame to generate a respective detection result. The respective detection result indicates pixels in the two-dimensional image that represent a road surface for the frame. The system then transforms the respective detection results for all cameras for the frame into segmentation masks for the frame. The transformation includes transforming a respective free space detection contour in each of the detection results into a corresponding segmentation mask for the frame. More details of generating detection results and segmentation masks are described above in connection with FIG. 2.

The system then generates a road mask representing road surface information based at least on the one or more segmentation masks generated for the frame (620). More specifically, the road mask is a bird's eye view (BEV) road mask, which is represented in a BEV coordinate frame. To generate a BEV road mask for a frame in the sequence of frames, the system generally fuses the segmentation masks generated for the frame captured by all cameras. The system repeatedly performs the operations for each frame of the sequence of frames to generate a sequence of BEV road masks, as described above.

In addition, the system can improve the quality of generated BEV road masks using various refining techniques. For example, the system can perform one or more morphological operations to refine one or more BEV road masks. One example of morphological operations can include open operations used to enhance or modify the geometrical structure of objects within an image, as described above. In addition, the system can perform one or more filtering techniques to denoise one or more BEV road masks. For example, the filtering technique can include one or more bilateral filtering operations, medium filtering operations, and Gaussian filtering operations.

Moreover, the system can further enhance the qualify for BEV road masks by generating a dense BEV road mask. This way, the system can combine sparse information from multiple BEV road masks to reduce noise and inaccuracy. To generate a dense BEV road mask, the system generally aggregates multiple BEV road masks for multiple frames. More specifically, the system selects a frame in the sequence of frames as a reference frame. According to the reference frame, the system converts one or more BEV road masks that are not associated with the reference frame to harmonize with the reference frame. The system then stacks the converted one or more BEV road masks in the reference frame to generate the dense BEV road mask. The dense BEV road masks can be applied for multiple frames in determining unlabeled objects. In some implementations, the reference frame can be a frame in the median position in the sequence of frames. The reference frame can also be a frame other than the median frame according to the different requirements for detecting unlabeled objects, as long as the reference frame is not the first or the last frame in a sequence of frames for generating the dense BEV road mask.

Moreover, to enhance efficiency and reduce computation costs, the system can generate a dense BEV road mask by selecting one or more BEV road masks in a sequence at a particular interview. For example, the system can select BEV road masks at an interval of two frames, three frames, five frames, or other suitable intervals. In some implementations, the system can perform inference operations using the dense BEV road masks for frames selected at a particular interval as well.

The system then generates a correlation between the first-type sensor data and the second-type sensor data for each frame in the sequence of frames (630). Assuming the first-type sensor is a LiDAR sensor, and the first-type sensor data includes a sequence of three-dimensional point clouds, which are described above, the system projects each point of the three-dimensional point cloud for the frame into the BEV coordinate frame; and matches the projected points with pixels in the two-dimensional images that represent the road surface. More specifically, the system can label points that are associated with pixels representing the road surface as “road.”

The system then filters, using the respective correlations and the road mask, the second-type sensor data to remove a portion of the second-type sensor data that are irrelevant to the unlabeled objects captured in the sequence of frames (640). More specifically, the system determines whether a projected point from a point cloud is located within the road region represented by the dense BEV road masks. If the projected point is not located within the road region, the system filters the projected point since it is not associated with an object on the road. In addition, the system determines whether a projected point within the road region is previously labeled. If the projected point is previously labeled, the system filters this projected point out since it is not associated with an unlabeled object on the road. In some implementations, the filtering operations using the BEV masks can be projected and performed in three-dimensional space.

The system clusters the remaining second-type sensor data in the sequence of frames to classify one or more unlabeled objects captured in the sensor data (650). In some implementations, the system can perform DBSCAN clustering on the filtered points in the BEV coordinate frame to generate multiple clusters. Each of the clusters represents a class of unlabeled objects on the road. As described above, unlabeled objects generally refer to objects that are not previously labeled in the received sensor data. These unlabeled objects can include animals, construction cones, construction signs, or other objects that are not normally labeled in the sensor data. This way, the described techniques can detect and analyze additional objects that are positioned on a road surface, which improves the perception and safety of autonomous driving.

In addition, the system can estimate 3D bounding boxes for the respective unlabeled objects based on the clusters. The system can generate output data representing the estimated bounding boxes for downstream analysis. Note that the system does not need to associate with a natural language name/tag with each of the clusters. Instead, the system can assign numerical, alphabetical, or other suitable labels to these clusters.

In some cases, the output data can further include one or more segmentation masks, one or more BEV masks, one or more dense BEV masks, one or more filtered point clouds, one or more three-dimensional clusters, and one or more numerical labels/bins for the clusters, as described above.

To expedite the inference process, particularly in real-time operations, the system can distribute operations across different computers and/or processors and instruct them to perform operations in parallel. Such parallel computation can be asynchronous, given the nature of the above-described techniques. For example, the system can assign operations for generating dense BEV road masks for a first set of processors or accelerators and assign operations associated with determining a correlation between the 2D images and 3D point clouds to a second set of processors or accelerators. The first and second sets of processors or accelerators do not have to perform operations synchronously since the two types of operations are barely coupled with each other. The filtering operations can be assigned to a third set of processors or accelerators, which can perform the filtering operations when the corresponding dense BEV road masks and the corresponding correlation data have been generated and transmitted to the third set of processors or accelerators.

In addition, the system can reduce the total computation cost by selectively processing some frames in the sequence of frames at a particular interval. To reduce further computation costs, the system can increase the interval for selecting frames in the sequence of frames. For example, the system can skip frames at the interval of one frame, two frames, five frames, or other suitable frames. By selectively skipping frames during the inference stage, the system reduces the number of frames to be processed as long as the accuracy level meets the requirement for detecting unlabeled objects. Moreover, the system can skip frames in the sequence of frames when generating the BEV road masks to further reduce the computation cost.

The term “machine learning model” throughout the specification stands for any suitable model used for machine learning. As an example, the machine learning model can include one or more neural networks trained for performing different inference tasks. Examples of neural networks and tasks performed by neural networks are described in greater detail at the end of the specification. For simplicity, the term “machine learning models” is sometimes referred to as “neural network models” or “deep neural networks” in the following specification.

Depending on the task, a neural network can be configured, i.e., through training, to receive any kind of digital data input and to generate any kind of score, classification, or regression output based on the input.

In some cases, the neural network is a neural network that is configured to perform an image processing task, i.e., receive an input image and process the input image to generate a network output for the input image. In this specification, processing an input image refers to processing the intensity values of the pixels of the image using a neural network. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories.

As another example, if the input to the neural network is a sequence of text in one language, the output generated by the neural network may be a score for each of a set of pieces of text in another language, with each score representing an estimated likelihood that the piece of text in the other language is a proper translation of the input text into the other language.

In some cases, the machine learning task is a combination of multiple individual machine learning tasks, i.e., the neural network is configured to perform multiple different individual machine learning tasks, e.g., two or more of the machine learning tasks mentioned above. For example, the neural network can be configured to perform multiple individual image processing or computer vision tasks, i.e., by generating the output for the multiple different individual image processing tasks in parallel by processing a single input image.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A program may, but need not, correspond to a file in a file system. A program can be stored in a portion of a file that holds other programs or data, e.g., one or more scripts stored in a markup language specification, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it, software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method for identifying unlabeled objects captured in sensor data representing one or more scenes in a sequence of frames, wherein the method comprises: receiving sensor data capturing unlabeled objects in one or more scenes in a sequence of frames, wherein the sensor data comprises first-type sensor data measured by one or more first-type sensors and second-type sensor data measured by a second-type sensor; processing, for each frame of the sequence of frames, the first-type sensor data measured by the one or more first-type sensors to generate one or more segmentation masks for the frame; generating a road mask representing road surface information based at least on the one or more segmentation masks generated for the frame; generating, for each frame in the sequence of frames, a correlation between the first-type sensor data and the second-type sensor data; filtering, using the respective correlations and the road mask, the second-type sensor data to remove a portion of the second-type sensor data that is irrelevant to the unlabeled objects captured in the sequence of frames; and clustering the remaining second-type sensor data in the sequence of frames to classify one or more unlabeled objects captured in the sensor data.

Embodiment 2 is the method of Embodiment 1, wherein the one or more first-type sensors comprise one or more cameras located on a vehicle, and the first-type sensor data comprise a respective sequence of two-dimensional image frames captured by a respective camera of the one or more cameras; and wherein the second-type sensor comprises a LiDAR sensor, and the second-type sensor data comprise a sequence of three-dimensional point clouds.

Embodiment 3 is the method of Embodiment 2, wherein processing, for each frame of the sequence of frames, the first-type sensor data measured by the one or more first-type sensors to generate the one or more segmentation masks for the frame, comprises: for each camera of the one or more cameras, processing a two-dimensional image captured by the camera for the frame to generate a respective detection result, the respective detection result indicating pixels in the two-dimensional image that represent a road surface for the frame; and transforming the respective detection results into one or more segmentation masks for the frame, comprising: transforming, for each of the respective detection results, a respective free space detection contour into a corresponding segmentation mask for the frame.

Embodiment 4 is the method of any Embodiment 1 to 3, wherein the road mask comprises a bird's eye view (BEV) road mask represented in a BEV coordinate frame, and wherein generating a road mask representing road surface information based at least on the one or more segmentation masks generated for the frame, comprises: for each frame of the sequence of frames, fusing the one or more segmentation masks for the frame to generate the BEV road mask for the frame.

Embodiment 5 is the method of Embodiment 4, further comprising refining the BEV road mask by performing one or more morphological operations or one or more bilateral filtering operations.

Embodiment 6 is the method of Embodiment 4 or 5, further comprising: generating a dense BEV road mask by aggregating a plurality of BEV road masks generated for respective frames, wherein the aggregation comprises: selecting a frame in the sequence of frames as a reference frame, converting one or more BEV road masks of the plurality of BEV road masks to the reference frame; and stacking the converted one or more BEV road masks to generate the dense BEV road mask.

Embodiment 7 is the method of Embodiment 6, wherein the reference frame is a frame in the median position in the sequence of frames.

Embodiment 8 is the method of Embodiment 6 or 7, wherein the one or more BEV road masks of the plurality of BEV road masks are selected at an interval in the sequence of frames.

Embodiment 9 is the method of any Embodiment 3 to 8, wherein generating, for each frame in the sequence of frames, the correlation between the first-type sensor data and the second-type sensor data comprises: projecting each point of the three-dimensional point cloud for the frame into a bird's eye view (BEV) coordinate frame; and matching the projected points with pixels in the two-dimensional images that represent the road surface.

Embodiment 10 is a system comprising one or more computers and one or more storage devices storing instructions that when executed by one or more computers cause the one or more computers to perform respective operations, the operations comprising the method of any one of Embodiments 1-9.

Embodiment 11 is one or more computer-readable storage media storing instructions that when executed by one or more computers cause the one or more computers to perform respective operations, the respective operations comprising the method of any one of Embodiments 1-9.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

What is claimed is:

1. A method for identifying unlabeled objects captured in sensor data representing one or more scenes in a sequence of frames, wherein the method comprises:
receiving sensor data capturing unlabeled objects in one or more scenes in a sequence of frames, wherein the sensor data comprises first-type sensor data measured by one or more first-type sensors and second-type sensor data measured by a second-type sensor;
processing, for each frame of the sequence of frames, the first-type sensor data measured by the one or more first-type sensors to generate one or more segmentation masks for the frame;
generating a road mask representing road surface information based at least on the one or more segmentation masks generated for the frame;
generating, for each frame in the sequence of frames, a correlation between the first-type sensor data and the second-type sensor data;
filtering, using the respective correlations and the road mask, the second-type sensor data to remove a portion of the second-type sensor data that is irrelevant to the unlabeled objects captured in the sequence of frames; and
clustering the remaining second-type sensor data in the sequence of frames to classify one or more unlabeled objects captured in the sensor data.

2. The method of claim 1, wherein the one or more first-type sensors comprise one or more cameras located on a vehicle, and the first-type sensor data comprise a respective sequence of two-dimensional image frames captured by a respective camera of the one or more cameras; and wherein the second-type sensor comprises a LiDAR sensor, and the second-type sensor data comprise a sequence of three-dimensional point clouds.

3. The method of claim 2, wherein processing, for each frame of the sequence of frames, the first-type sensor data measured by the one or more first-type sensors to generate the one or more segmentation masks for the frame, comprises:
for each camera of the one or more cameras, processing a two-dimensional image captured by the camera for the frame to generate a respective detection result, the respective detection result indicating pixels in the two-dimensional image that represent a road surface for the frame; and
transforming the respective detection results into one or more segmentation masks for the frame, comprising: transforming, for each of the respective detection results, a respective free space detection contour into a corresponding segmentation mask for the frame.

4. The method of claim 1, wherein the road mask comprises a bird's eye view (BEV) road mask represented in a BEV coordinate frame, and wherein generating the road mask representing road surface information based at least on the one or more segmentation masks generated for the frame, comprises:
for each frame of the sequence of frames, fusing the one or more segmentation masks for the frame to generate the BEV road mask for the frame.

5. The method of claim 4, further comprising:
refining the BEV road mask by performing one or more morphological operations or one or more filtering operations, wherein the one or more filtering operations comprise using a bilateral filter, a median filter, or a Gaussian filter.

6. The method of claim 4, further comprising:
generating a dense BEV road mask by aggregating a plurality of BEV road masks generated for respective frames, wherein the aggregation comprises:
selecting a frame in the sequence of frames as a reference frame,
converting one or more BEV road masks of the plurality of BEV road masks to the reference frame; and
stacking the converted one or more BEV road masks to generate the dense BEV road mask.

7. The method of claim 6, wherein the reference frame is a frame in the median position in the sequence of frames.

8. The method of claim 6, wherein the one or more BEV road masks of the plurality of BEV road masks are selected at an interval in the sequence of frames.

9. The method of claim 3, wherein generating, for each frame in the sequence of frames, the correlation between the first-type sensor data and the second-type sensor data comprises:
projecting each point of the three-dimensional point cloud for the frame into a bird's eye view (BEV) coordinate frame; and
matching the projected points with pixels in the two-dimensional images that represent the road surface.

10. A system comprising one or more computers and one or more storage devices storing instructions that when executed by one or more computers cause the one or more computers to perform respective operations, the operations comprising:
receiving sensor data capturing unlabeled objects in one or more scenes in a sequence of frames, wherein the sensor data comprises first-type sensor data measured by one or more first-type sensors and second-type sensor data measured by a second-type sensor;
processing, for each frame of the sequence of frames, the first-type sensor data measured by the one or more first-type sensors to generate one or more segmentation masks for the frame;
generating a road mask representing road surface information based at least on the one or more segmentation masks generated for the frame;
generating, for each frame in the sequence of frames, a correlation between the first-type sensor data and the second-type sensor data;
filtering, using the respective correlations and the road mask, the second-type sensor data to remove a portion of the second-type sensor data that is irrelevant to the unlabeled objects captured in the sequence of frames; and
clustering the remaining second-type sensor data in the sequence of frames to classify one or more unlabeled objects captured in the sensor data.

11. The system of claim 10, wherein the one or more first-type sensors comprise one or more cameras located on a vehicle, and the first-type sensor data comprise a respective sequence of two-dimensional image frames captured by a respective camera of the one or more cameras; and wherein the second-type sensor comprises a LiDAR sensor, and the second-type sensor data comprise a sequence of three-dimensional point clouds.

12. The system of claim 11, wherein processing, for each frame of the sequence of frames, the first-type sensor data measured by the one or more first-type sensors to generate the one or more segmentation masks for the frame, comprises:
for each camera of the one or more cameras, processing a two-dimensional image captured by the camera for the frame to generate a respective detection result, the respective detection result indicating pixels in the two-dimensional image that represent a road surface for the frame; and
transforming the respective detection results into one or more segmentation masks for the frame, comprising: transforming, for each of the respective detection results, a respective free space detection contour into a corresponding segmentation mask for the frame.

13. The system of claim 12, wherein the road mask comprises a bird's eye view (BEV) road mask represented in a BEV coordinate frame, and wherein generating a road mask representing road surface information based at least on the one or more segmentation masks generated for the frame, comprises:
for each frame of the sequence of frames, fusing the one or more segmentation masks for the frame to generate the BEV road mask for the frame.

14. The system of claim 13, wherein the operations further comprise:
refining the BEV road mask by performing one or more morphological operations or one or more filtering operations, wherein the one or more filtering operations comprise using a bilateral filter, a median filter, or a Gaussian filter.

15. The system of claim 13, wherein the operations further comprise:
generating a dense BEV road mask by aggregating a plurality of BEV road masks generated for respective frames, wherein the aggregation comprises:
selecting a frame in the sequence of frames as a reference frame,
converting one or more BEV road masks of the plurality of BEV road masks to the reference frame; and
stacking the converted one or more BEV road masks to generate the dense BEV road mask.

16. One or more computer-readable storage media storing instructions that when executed by one or more computers cause the one or more computers to perform respective operations, the respective operations comprising:
receiving sensor data capturing unlabeled objects in one or more scenes in a sequence of frames, wherein the sensor data comprises first-type sensor data measured by one or more first-type sensors and second-type sensor data measured by a second-type sensor;
processing, for each frame of the sequence of frames, the first-type sensor data measured by the one or more first-type sensors to generate one or more segmentation masks for the frame;
generating a road mask representing road surface information based at least on the one or more segmentation masks generated for the frame;
generating, for each frame in the sequence of frames, a correlation between the first-type sensor data and the second-type sensor data;
filtering, using the respective correlations and the road mask, the second-type sensor data to remove a portion of the second-type sensor data that is irrelevant to the unlabeled objects captured in the sequence of frames; and
clustering the remaining second-type sensor data in the sequence of frames to classify one or more unlabeled objects captured in the sensor data.

17. The one or more computer-readable storage media of claim 16, wherein the one or more first-type sensors comprise one or more cameras located on a vehicle, and the first-type sensor data comprise a respective sequence of two-dimensional image frames captured by a respective camera of the one or more cameras; and wherein the second-type sensor comprises a LiDAR sensor, and the second-type sensor data comprise a sequence of three-dimensional point clouds.

18. The one or more computer-readable storage media of claim 17, wherein processing, for each frame of the sequence of frames, the first-type sensor data measured by the one or more first-type sensors to generate the one or more segmentation masks for the frame, comprises:
for each camera of the one or more cameras, processing a two-dimensional image captured by the camera for the frame to generate a respective detection result, the respective detection result indicating pixels in the two-dimensional image that represent a road surface for the frame; and
transforming the respective detection results into one or more segmentation masks for the frame, comprising: transforming, for each of the respective detection results, a respective free space detection contour into a corresponding segmentation mask for the frame.

19. The one or more computer-readable storage media of claim 18, wherein the road mask comprises a bird's eye view (BEV) road mask represented in a BEV coordinate frame, and wherein generating a road mask representing road surface information based at least on the one or more segmentation masks generated for the frame, comprises:
for each frame of the sequence of frames, fusing the one or more segmentation masks for the frame to generate the BEV road mask for the frame.

20. The one or more computer-readable storage media of claim 19, wherein the operations further comprise:
refining the BEV road mask by performing one or more morphological operations or one or more filtering operations, wherein the one or more filtering operations comprise using a bilateral filter, a median filter, or a Gaussian filter.
